(19) United States
(12) Patent Application Publication
(10) Pub. No.: US 2013/0163800 A1
(43) Pub. Date: Jun. 27, 2013

(54) SPEAKER DEVICE

(71) Applicant: Shuhei YAMASAKI, Osaka (JP)

(72) Inventor: Shuhei YAMASAKI, Osaka (JP)

(73) Assignee: PANASONIC CORPORATION, Osaka (JP)

(21) Appl. No.: 13/586,106

(22) Filed: Aug. 15, 2012

(30) Foreign Application Priority Data
Dec. 27, 2011 (JP) 2011-285018

(51) Int. Cl. H04R 1/02

(52) U.S. Cl. 381/332

(57) ABSTRACT

A speaker device includes a speaker unit configured to reproduce a bass sound and arranged so as to face down; a bottom plate formed in a rectangular shape as viewed in plane and arranged apart from the speaker unit such that an upper surface of the bottom plate opposes the speaker unit; and four legs attached to a lower surface of the bottom plate. The four legs are provided respectively on lines each connecting between an intersection point of diagonal lines of the lower surface of the bottom plate and a corner of the lower surface of the bottom plate in a region where a ratio of a distance between the intersection point and an attachment position of the leg to a distance between the intersection point and the corner is 0.5-0.7.

### CROSS-REFERENCE TO RELATED APPLICATION

This application claims priority to Japanese Patent Application No. 2011-285018 filed on Dec. 27, 2011, the disclosure of which including the specification, the drawings, and the claims is hereby incorporated by reference in its entirety.

### BACKGROUND

The present disclosure relates to a speaker device, and particularly relates to a speaker device specifically for low frequency reproduction.

As a speaker device, a low frequency reproduction speaker device configured to reproduce a so-called “deep bass sound” has been known. A low frequency sound reproduced by the speaker device of this type sometimes vibrates an object. A speaker device has been disclosed, in which four legs are attached to the bottom of a rectangular parallelepiped speaker box in order to reduce transmission of vibration of equal to or less than about 100-150 Hz to a vehicle (e.g., see Japanese Patent Publication No. H10-243487).

For a better sound quality obtained by the highest possible directivity or a better design of a speaker, a down-firing type speaker device in which a speaker unit is attached so as to face down has been employed as the low frequency reproduction speaker device. In the down-firing type speaker device, a plate (hereinafter referred to as a “bottom plate”) is provided so as to oppose the speaker unit in order to allow bass sound reproduction regardless of, e.g., the material and shape of a floor in an installation site and to protect the speaker device. In the case where the strength of the bottom plate is low, when the speaker unit is driven, the bottom plate itself vibrates due to a resonance frequency of the bottom plate, and such vibration causes unnecessary resonance noise. As a result, bass sound qualities such as senses of massiveness and speed are significantly degraded. Thus, e.g., the following countermeasures have been taken: using a high-strength material such as lumbers or stones for a bottom plate, or attaching a reinforcing material to a thin bottom plate made of resin.

### SUMMARY

However, as in the down-firing type speaker device, if the high-strength material such as lumbers or stones is used for the bottom plate, or the reinforcing material is attached to the thin bottom plate made of resin, the number of manufacturing steps is increased, resulting in low mass-productivity and a cost increase. Thus, the down-firing type speaker device has been impracticable.

In one general aspect, the present disclosure describes a speaker device manufactured with a reduced cost and high mass-productivity and configured to reproduce a bass sound having less unnecessary noise.

In view of the foregoing, the speaker device of the present disclosure is configured as follows. The speaker device includes a speaker unit configured to reproduce a bass sound and arranged so as to face down; a bottom plate formed in a rectangular shape as viewed in plane and arranged apart from the speaker unit such that an upper surface of the bottom plate opposes the speaker unit; and four legs attached to a lower surface of the bottom plate. The four legs are provided respectively on lines each connecting between an intersection point of diagonal lines of the lower surface of the bottom plate and a corner of the lower surface of the bottom plate and in a region where a ratio of a distance between the intersection point and an attachment position of the leg to a distance between the intersection point and the corner is 0.5-0.7.

According to the foregoing configuration, the bottom plate is formed in the rectangular shape as viewed in plane, and is arranged apart from the speaker unit such that the upper surface of the bottom plate opposes the speaker unit arranged to face down. That is, a sound reproduced by the speaker unit is emitted toward the upper surface of the bottom plate. The four legs are attached to the lower surface of the bottom plate on the diagonal lines in the predetermined region. In the predetermined region, the ratio of the distance between the intersection point of the diagonal lines of the bottom plate and the attachment position of the leg to the distance between the intersection point and the corner of the bottom plate is 0.5-0.7 on the diagonal lines.

Even if the speaker unit is driven, and the bottom plate vibrates due to a resonance frequency of the bottom plate itself, such vibration is reduced by the four legs attached to the bottom plate within the predetermined region. Thus, occurrence of unnecessary noise can be reduced. In addition, even if the bottom plate is made of, e.g., an inexpensive easily-processable material, the vibration can be reduced by attaching the four legs to the bottom plate within the predetermined region. That is, a speaker device manufactured with a reduced cost and high mass-productivity and configured to reproduce a bass sound having less unnecessary noise can be provided.

According to the present disclosure, the speaker device manufactured with the reduced cost and the high mass-productivity and configured to reproduce the bass sound having less unnecessary noise can be provided.

### BRIEF DESCRIPTION OF THE DRAWINGS

FIG. 1 is a perspective view illustrating a speaker device of an embodiment.

FIG. 2 is a perspective view of a bottom plate of the embodiment.

FIG. 3 is a view of the bottom plate of the embodiment from below.

FIG. 4 is a graph illustrating simulation results of the embodiment.

FIG. 5 is a graph used for analyzing suitable attachment positions of legs.

FIG. 6 is a view illustrating an area where the legs are attached to the bottom plate of the embodiment.

FIG. 7 is a view illustrating another example of the bottom plate of the speaker device illustrated in FIG. 1.

### DETAILED DESCRIPTION

Embodiment(s) is described in detail below with reference to the attached drawings. However, unnecessarily detailed description may be omitted. For example, detailed description of well known techniques or description of the substantially same elements may be omitted. Such omission is intended to prevent the following description from being unnecessarily redundant and to help those skilled in the art easily understand it.

Inventor(s) provides the following description and the attached drawings to enable those skilled in the art to fully understand the present disclosure. Thus, the description and the drawings are not intended to limit the scope of the subject matter defined in the claims.

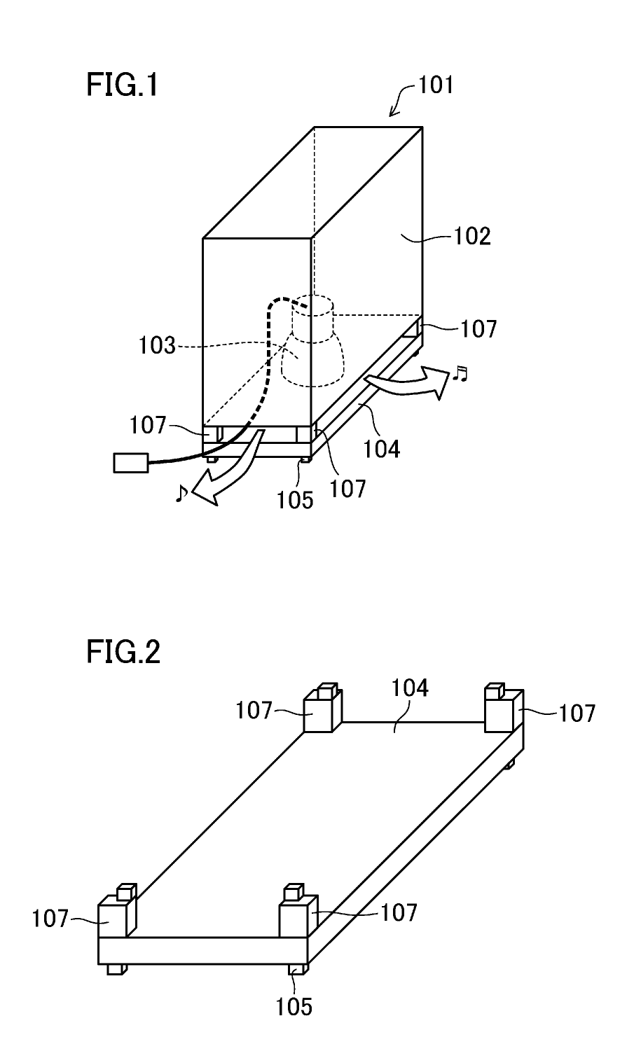

FIG. 1 is a perspective view illustrating a speaker device of an embodiment. A speaker device 101 of the present embodiment is a down-firing type speaker device specifically for low frequency reproduction. The speaker device 101 includes a speaker box cabinet 102, a speaker unit 103 serving as a driver, a bottom plate 104, and legs 105.

In the speaker box cabinet 102, the speaker unit 103 is attached to the bottom of the speaker box cabinet 102 so as to face down. The speaker unit 103 is arranged in a center part of the bottom of the speaker box cabinet 102. The speaker unit 103 reproduces a low frequency sound, i.e., a so-called “deep bass sound.” Note that the frequency of the low frequency sound is about 20-200 Hz. In addition, the speaker unit 103 may be arranged in any part of the bottom of the speaker box cabinet 102.

The speaker box cabinet 102 is in a rectangular parallelepiped shape, and the capacity thereof is about 15 L.

The bottom plate 104 is formed in a rectangular shape as viewed in plane, and is arranged apart from the bottom of the speaker box cabinet 102. Specifically, an upper surface of the bottom plate 104 opposes the bottom of the speaker box cabinet 102. Four corners of the bottom plate 104 and four corners of the speaker box cabinet 102 are connected together through connection members 107. Thus, a sufficient clearance through which a sound is emitted can be ensured between the bottom plate 104 and the speaker box cabinet 102.

The legs 105 are attached respectively to four parts of a lower surface of the bottom plate 104. The attachment positions of the four legs 105 will be specifically described later.

FIG. 2 is a perspective view of the bottom plate of the embodiment. In the present embodiment, the bottom plate 104 is made of, e.g., inexpensive easily-processable resin.

In the speaker device 101 having the foregoing configuration, when a sound signal is input to the speaker unit 103, the speaker unit 103 vibrates to reproduce a sound. Then, the sound is reflected by a center part of the bottom plate 104, and is emitted through the clearance between the speaker box cabinet 102 and the bottom plate 104.

Depending on the positions of the four legs 105 attached to a bottom surface of the bottom plate 104, large vibration of the bottom plate 104 may be caused due to a resonance frequency of the bottom plate 104. Thus, the present inventors have conducted a simulation of a relationship among the attachment positions of the legs 105 and the vibration of the bottom plate 104 in order to determine the attachment positions of the legs 105 allowing effective vibration reduction.

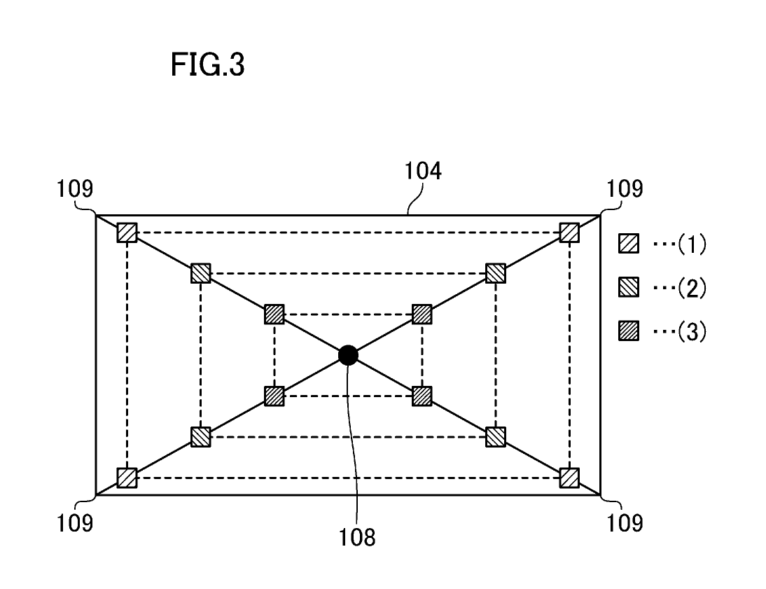

FIG. 3 is a view of the bottom plate from below. In the simulation of the present embodiment, a bottom plate 104 having dimensions of 299 mm×179 mm was used. For the simulation, the position of each of the leg 105 was set to three different points of a lower surface of the bottom plate 104 on a line connecting between a center part 108 having an intersection point of diagonal lines and a corner 109.

Specifically, reference numerals (1)-(3) in FIG. 3 represent the attachment positions of the four legs 105. The attachment position (1) is the position at which a distance from the center part 108 is about 146 mm. The attachment position (2) is the position at which the distance from the center part 108 is about 96 mm. The attachment position (3) is the position at which the distance from the center part 108 is about 42 mm.

The simulation was conducted for each case where the four legs 105 are attached respectively to the attachment positions (1), (2), or (3) by using modal frequency response analysis. In the simulation, vertical vibration of a speaker unit 103 at intensity of 1 N was a loading condition. In addition, a vibration evaluation position was in the center part 108 of the bottom plate 104, and an amplitude of the vertical vibration in such a position was calculated.

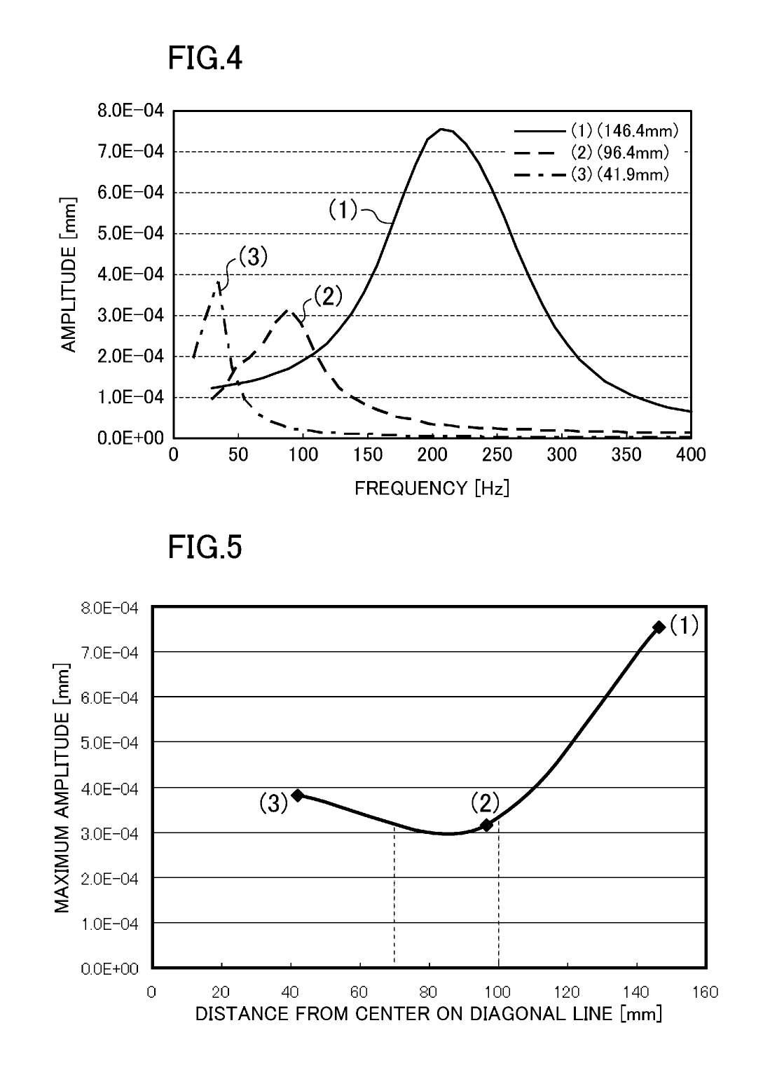

FIG. 4 is a graph illustrating simulation results. The horizontal axis represents a frequency, and the vertical axis represents an amplitude. Note that the results (1)-(3) of FIG. 4 correspond to the attachment positions (1)-(3) of FIG. 3, respectively, and plots the simulation results in the attachment positions (1)-(3). The results show that the maximum amplitude of the vibrating bottom plate 104 is the smallest in the attachment positions (2), and therefore the attachment positions (2) are suitable positions to which the legs 105 are respectively attached.

Next, more suitable attachment positions of the legs 105 were analyzed based on the simulation results illustrated in FIG. 4.

FIG. 5 is a graph used for analyzing the suitable attachment positions. In FIG. 5, the horizontal axis represents a distance from the center part 108 to the attachment position on the diagonal line of the bottom plate 104, and the vertical axis represents the maximum amplitude of the vibrating bottom plate 104. Values (1)-(3) of FIG. 5 correspond to the attachment positions (1)-(3) of FIG. 3, respectively, and also correspond to the results (1)-(3) of FIG. 4, respectively. FIG. 5 plots the attachment positions (1)-(3) of FIG. 3 and the results (1)-(3) of FIG. 4, and a function for calculating the suitable attachment positions of the legs 105 is obtained.

Referring to FIG. 5, since the maximum amplitude is significantly small when the distance from the center part 108 to the attachment position in the bottom plate 104 is within a range of about 70-100 mm, it is assumed that the legs 105 are suitably attached within the foregoing range.

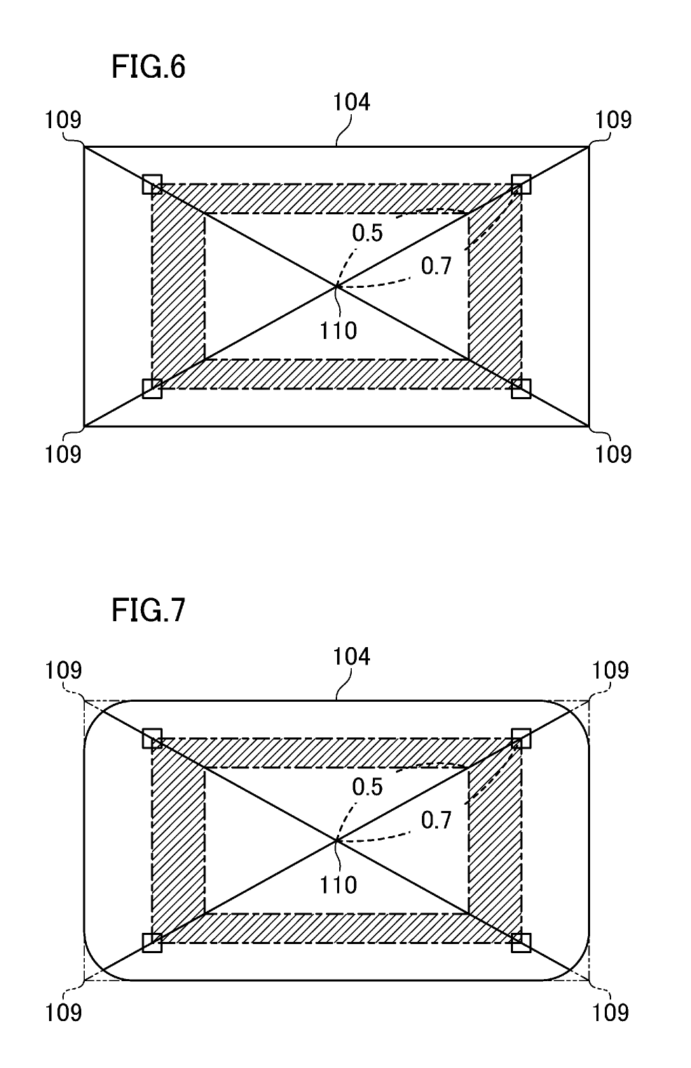

Specifically, as illustrated in FIG. 6, suppose that, on a line connecting between an intersection point 110 of the diagonal lines of the lower surface of the bottom plate 104 to the corner 109, a distance from the intersection point 110 to the corner 109 is the maximum distance. It is assumed that, if the ratio of a distance between the intersection point 110 and the attachment position to the maximum distance falls within a range of 0.5-0.7, the maximum amplitude of the vibrating bottom plate 104 is decreased. That is, if the legs 105 are arranged respectively in four different areas which each are on the diagonal line of the bottom plate 104 in a shaded region illustrated in FIG. 6, a vibration reduction effect is enhanced. Note that, although the smaller maximum amplitude is preferable, an allowable maximum amplitude range of the bottom plate 104 can be freely set.

The range in which the foregoing ratio is 0.5-0.7 is a suitable range for a better sound obtained by reducing unnecessary noise caused due to the vibration of the bottom plate 104. In the present embodiment, further analysis on a sound reproduced by the speaker device 101 was conducted for three positions at which the foregoing ratio is 0.65, 0.7, and 0.75, considering stability of the speaker device 101.

Results showing that the position at which the foregoing ratio is 0.65 is suitable were obtained. Thus, for the better sound and the stable speaker device 101, it is preferable that the four legs 105 are attached respectively to the four different positions at each of which the foregoing ratio is 0.65.

According to the foregoing embodiment, the attachment of the legs 105 to the suitable positions of the bottom plate 104 can effectively reduce the vibration of the bottom plate 104 due to the resonance frequency thereof. Thus, it is less likely that unnecessary noise is caused. In addition, the bottom plate 104 made of the inexpensive easily-processable resin allows mass production of the bottom plate 104 and cost reduction.

The planer shape of the bottom plate 104 is not necessarily the exact rectangular shape. For example, referring to FIG. 7, end parts of the bottom plate 104 may be rounded.

Alternatively, the bottom plate 104 may be in a square shape as viewed in plane. In such a case, the end parts of the bottom plate 104 may be also rounded.

The legs 105 are not necessarily attached on the diagonal lines of the bottom plate 104. For example, as long as the four legs 105 are, in the shaded region illustrated in FIGS. 6 and 7, attached to the positions at which the legs 105 can stably support the bottom plate 104, the effect of reducing the vibration of the bottom plate 104 may be exhibited.

A change in dimensions of the bottom plate 104 results in a change in resonant frequency of the bottom plate 104. However, the same function obtained by connecting the points at which the amplitude is the maximum as illustrated in FIG. 5 is applied for the bottom plates 104 having different dimensions. Thus, a smaller dimensions of the bottom plate 104 result in a higher resonant frequency, and a larger dimensions of the bottom plate 104 result in a lower resonant frequency. Consequently, even if the dimensions of the bottom plate 104 are changed, the foregoing advantages can be still realized.

Various embodiments have been described above as example techniques of the present disclosure, in which the attached drawings and the detailed description are provided.

As such, elements illustrated in the attached drawings or the detailed description may include not only essential elements for solving the problem, but also non-essential elements for solving the problem in order to illustrate such techniques. Thus, the mere fact that those non-essential elements are shown in the attached drawings or the detailed description should not be interpreted as requiring that such elements be essential.

Since the embodiments described above are intended to illustrate the techniques in the present disclosure, it is intended by the following claims to claim any and all modifications, substitutions, additions, and omissions that fall within the proper scope of the claims appropriately interpreted in accordance with the doctrine of equivalents and other applicable judicial doctrines.

The speaker device of the present disclosure is useful to manufacture the speaker device with the reduced cost and the improved productivity and reproduce the bass sound having less unnecessary noise.

What is claimed is:

1. A speaker device, comprising:
a speaker unit configured to reproduce a bass sound and arranged so as to face down;
a bottom plate formed in a rectangular shape as viewed in plane and arranged apart from the speaker unit such that an upper surface of the bottom plate opposes the speaker unit; and
four legs attached to a lower surface of the bottom plate,
wherein the four legs are provided respectively on lines each connecting between an intersection point of diagonal lines of the lower surface of the bottom plate and a corner of the lower surface of the bottom plate in a region where a ratio of a distance between the intersection point and an attachment position of the leg to a distance between the intersection point and the corner is 0.5-0.7.

2. The speaker device of claim 1, wherein the four legs are attached respectively to positions at which the ratio is 0.65.
